(19) United States
(12) Patent Application Publication
(10) Pub. No.: US 2019/0212907 A1
(43) Pub. Date: Jul. 11, 2019

(54) METHOD AND SYSTEM FOR ADJUSTING PARAMETER OF MOBILE TERMINAL DEVICE, AND MOBILE TERMINAL DEVICE

(71) Applicant: SHENZHEN ROYOLE TECHNOLOGIES CO. LTD., Shenzhen (CN)

(72) Inventor: Chao HAN, Shenzhen (CN)

(21) Appl. No.: 16/356,612

(22) Filed: Mar. 18, 2019

Related U.S. Application Data
(63) Continuation of application No. PCT/CN2016/111437, filed on Dec. 22, 2016.

(51) Int. Cl. G06F 3/0484; G06F 3/0488; G06F 3/041; G06F 3/0481; G06F 3/0482

(52) U.S. Cl. CPC G06F 3/04847; G06F 3/04883; G06F 3/0482; G06F 3/04817; G06F 3/0414

(57) ABSTRACT

A method for adjusting a parameter includes: detecting a touch pressure on a touch screen of the mobile terminal device; determining whether the touch pressure is greater than a preset pressure; sending a first initiating command when the touch pressure is less than the preset pressure; initiating a coarse parameter adjustment mode in response to the first initiating command; where in the coarse parameter adjustment mode, a parameter increment corresponding to a unit sliding distance is equal to a first increment; sending a second initiating command when the touch pressure is greater than or equal to the preset pressure; and initiating a fine parameter adjustment mode in response to the second initiating command; where in the fine parameter adjustment mode, a parameter increment corresponding to the unit sliding distance is equal to a second increment; and the second increment is smaller than the first increment.

### CROSS-REFERENCE TO RELATED APPLICATION

This application is a continuation of PCT/CN2016/111437, filed on Dec. 22, 2016, the disclosure of which is hereby incorporated by reference in its entirety.

### TECHNICAL FIELD

The application relates to the field of mobile terminal devices, more particularly to a method for adjusting a parameter of a mobile terminal device, a system for adjusting the parameter of the mobile terminal device, and the mobile terminal device.

### BACKGROUND

With the development of the technology of mobile terminal devices, more and more mobile terminal devices with various functions are emerging, such as virtual reality headsets. As an intelligent processing terminal device, the mobile terminal device needs to generate different audible feedbacks for different behaviors. Users often want to acquire the volume feedbacks from different behaviors under control of the mobile terminal device. Especially for the virtual reality headsets, system volume adjusted by the users with a touch screen under an invisible situation is inaccurate, thus failing to meet the user's application requirements.

### SUMMARY

An exemplary embodiment of the present disclosure provides a method for adjusting a parameter of a mobile terminal device, thus the parameter of the mobile terminal device may be accurately adjusted according to an actual need to meet the user's application requirements.

An exemplary embodiment of the present disclosure provides a system for adjusting a parameter of a mobile terminal device and the mobile terminal device.

An exemplary embodiment of the present disclosure provides a method for adjusting a parameter of a mobile terminal. The method for adjusting the parameter of the mobile terminal device includes:
detecting a touch pressure on a touch screen of the mobile terminal device;
determining whether the touch pressure is greater than a preset pressure;
sending a first initiating command when the touch pressure is less than the preset pressure;
initiating a coarse parameter adjustment mode in response to the first initiating command, where in the coarse parameter adjustment mode, a parameter increment corresponding to a unit sliding distance is equal to a first increment;
sending a second initiating command when the touch pressure is greater than or equal to the preset pressure; and
initiating a fine parameter adjustment mode in response to the second initiating command; where in the fine parameter adjustment mode, a parameter increment corresponding to the unit sliding distance is equal to a second increment; and where the second increment is smaller than the first increment.

An exemplary embodiment of the present disclosure provides a system for adjusting the parameter of the mobile terminal device. The method for adjusting the parameter of the mobile terminal device includes a detecting unit, a determining unit, and an initiating unit; the detecting unit is configured to detect a touch pressure on a touch screen of the mobile terminal device; the determining unit is configured to determine whether the touch pressure is greater than a preset pressure; send a first initiating command when the touch pressure is less than the preset pressure, and send a second initiating command when the touch pressure is greater than or equal to the preset pressure; the initiating unit is configured to initiate a coarse parameter adjustment mode in response to the first initiating command and a fine parameter adjustment mode in response to the second initiating command, where in the coarse parameter adjustment mode, a parameter increment corresponding to a unit sliding distance is equal to a first increment; in the fine parameter adjustment mode, a parameter increment corresponding to the unit sliding distance is equal to a second increment; and the second increment is smaller than the first increment.

An exemplary embodiment of the present disclosure further provides a mobile terminal device including the above system for adjusting the parameter.

A method for adjusting a parameter includes detecting a touch pressure on a touch screen of the mobile terminal device; determining whether the touch pressure is greater than a preset pressure; sending a first initiating command when the touch pressure is less than the preset pressure; initiating a coarse parameter adjustment mode in response to the first initiating command, where in the coarse parameter adjustment mode, a parameter increment corresponding to a unit sliding distance is equal to a first increment; sending a second initiating command when the touch pressure is greater than or equal to the preset pressure; and initiating a fine parameter adjustment mode in response to the second initiating command; where in the fine parameter adjustment mode, a parameter increment corresponding to the unit sliding distance is equal to a second increment; and the second increment is smaller than the first increment. Thus, in the method for adjusting a parameter, the coarse parameter adjustment mode or the fine parameter adjustment mode is alternatively selected to adjust the parameter in response to different touch pressures, that is, the parameter of the mobile terminal device is accurately adjusted according to an actual need to meet the user's application requirements.

### BRIEF DESCRIPTION OF THE DRAWINGS

In order to more clearly illustrate the technical solutions in the exemplary embodiments of the present disclosure, the accompanying drawings used in the description of the exemplary embodiments will be briefly described below. Obviously, the accompanying drawings in the following description are only some embodiments of the present disclosure. Those skilled in the art can also obtain other drawings based on these drawings without paying any creative work.

FIG. 1 is a flowchart of a method for adjusting the parameter of the mobile terminal device provided by an exemplary embodiment of a first implementation of the present disclosure.

FIG. 2 is a flowchart of blocks 107-109 of the method of FIG. 1 after initiating a fine parameter adjustment mode.

FIG. 3 is a flowchart of blocks 201-204 of the method of FIG. 1 after initiating the fine parameter adjustment mode.

FIG. 4 is a block diagram of a system for adjusting the parameter of a mobile terminal device provided by an exemplary embodiment of a second implementation of the present disclosure.

FIG. 5 is a block diagram of another system for adjusting the parameter of a mobile terminal device provided by an exemplary embodiment of a third implementation of the present disclosure.

### DETAILED DESCRIPTION

The technical solutions in the in the exemplary embodiments of the present disclosure will be clearly and completely described below in conjunction with the accompanying drawings of the exemplary embodiments of the present disclosure.

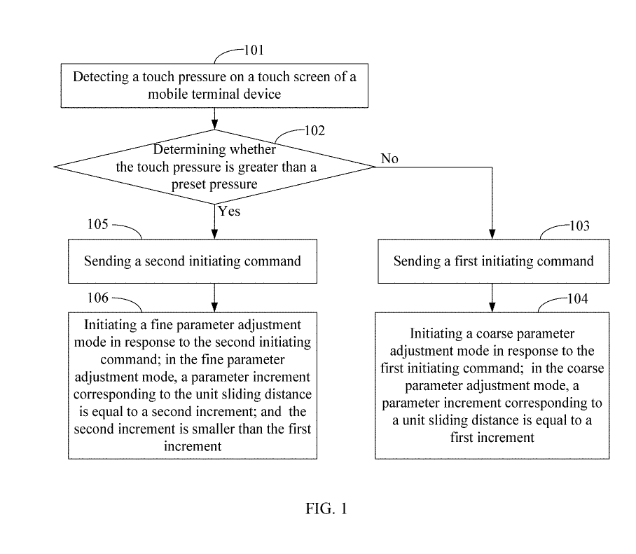

As illustrated FIG. 1, an exemplary embodiment of a first implementation of the present disclosure provides a method for adjusting a parameter of a mobile terminal device. The method for adjusting the parameter of the mobile terminal device includes the following steps.

At block 101, a touch pressure on a touch screen of the mobile terminal device is detected.

The mobile terminal device may be a headset, such as a head mount display. When a user needs to adjust some adjustable parameters of the mobile terminal device, the user may touch the touch screen firstly, and then slide on the touch screen to complete the adjustment of the corresponding parameter.

At block 102, the mobile terminal device determines whether the touch pressure is greater than a preset pressure.

It is noted that, the preset pressure is configured to determine whether the user needs to select the coarse parameter adjustment mode or the fine parameter adjustment mode. Thus, the preset pressure may be adjusted according to an actual need.

At block 103, when the touch pressure is less than the preset pressure, a first initiating command is sent by the mobile terminal device.

When the touch pressure is less than the preset pressure, it indicates that the user needs to coarse adjust the parameter. At block 104, a coarse parameter adjustment mode is initiated in response to the first initiating command. In the coarse parameter adjustment mode, a parameter increment corresponding to the unit sliding distance is equal to a first increment.

The coarse parameter adjustment mode is initiated in response to the first initiating command, that is, the mobile terminal device is in the coarse parameter adjustment mode. The parameter may be any attribute adjustable under control of the mobile terminal device, such as volume, brightness, or progress. In the exemplary embodiment, the parameter is volume. In other embodiments, the parameter may be brightness or progress.

It is noted that, in the exemplary embodiment, the parameter increment corresponding to the unit sliding distance is the volume increment corresponding to the unit sliding distance, which is Δ=V/L, where, L represents the volume sliding distance; and V represents the total volume. Therefore, the volume increment corresponding to the unit sliding distance is ΔV=Δ*ΔL, where, ΔV represents the variation of the volume when the touch displacement variation is ΔL.

In the coarse parameter adjustment mode, the parameter increment corresponding to a unit sliding distance is Δ=V/L, then ΔV1=Δ1*ΔL1.

At block 105, when the touch pressure is greater than or equal to the preset pressure, a second initiating command is sent.

When the touch pressure is greater than or equal to the preset pressure, it indicates that the user needs to fine adjust the parameter.

At block 106, a fine parameter adjustment mode is initiated in response to the second initiating command. In the fine parameter adjustment mode, a parameter increment corresponding to the unit sliding distance is equal to a second increment; and the second increment is smaller than the first increment.

It is noted that, the second increment may also be generated by directly reducing the first increment until the parameter increment corresponding to a unit sliding distance is equal to the second increment, which is in the fine parameter adjustment mode.

It is noted that, in the fine parameter adjustment mode, the parameter increment corresponding to a unit sliding distance is Δ2=V/L, then ΔV2=Δ2*ΔL2. When a touch displacement variation in the fine parameter adjustment mode is the same as the touch displacement variation in the coarse parameter adjustment mode, that is, ΔL1=ΔL2. If the volume increment Δ2 is less than the volume increment Δ1, the ΔV2 is smaller than ΔV1. Therefore, compared with the coarse parameter adjustment mode, when the touch displacement variations ΔL are the same, the volume variation of the fine parameter adjustment mode is smaller, thereby achieving a fine adjustment of the volume.

Therefore, in the exemplary embodiment, the method for adjusting a parameter includes the following steps. a touch pressure on a touch screen of the mobile terminal device is detected; whether the touch pressure is greater than a preset pressure is determined; a first initiating command is sent when the touch pressure is less than the preset pressure; a coarse parameter adjustment mode is initiated in response to the first initiating command, where in the coarse parameter adjustment mode, a parameter increment corresponding to a unit sliding distance is equal to a first increment; a second initiating command is sent when the touch pressure is greater than or equal to the preset pressure; and a fine parameter adjustment mode in response to the second initiating command is initiated; where in the fine parameter adjustment mode, a parameter increment corresponding to the unit sliding distance is equal to a second increment; and the second increment is smaller than the first increment. Thus, in the method for adjusting a parameter, the coarse parameter adjustment mode or the fine parameter adjustment mode is alternatively selected to adjust the parameter in response to the touch pressure, that is, the parameter of the mobile terminal device is accurately adjusted according to an actual need to meet the user's application requirements.

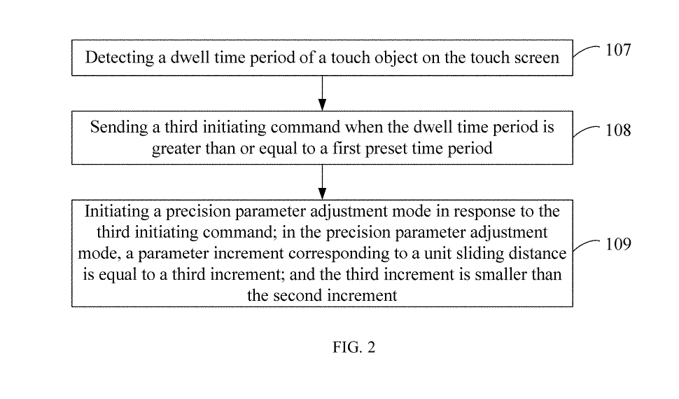

As illustrated in FIG. 2, after initiating the fine parameter adjustment mode, the method further includes the following steps.

At block 107, a dwell time period of a touch object on the touch screen is detected.

At block 108, when the dwell time period is greater than or equal to a first preset time period, a third initiating command is sent.

It is noted that, when the dwell time period of the touch object on the touch screen is greater than the first preset time period, it indicates that the user wants a fine adjustment of the volume.

At block 109, a precision parameter adjustment mode is initiated in response to the third initiating command. In the precision parameter adjustment mode, a parameter increment corresponding to the unit sliding distance is equal to a third increment; and the third increment is smaller than the second increment.

It is noted that, in the precision parameter adjustment mode, the parameter increment corresponding to the unit sliding distance is Δ3=V/L, then ΔV3=Δ3*ΔL3. When a touch displacement variation in the precision parameter adjustment mode is the same as the touch displacement variation in the fine parameter adjustment mode, that is, ΔL3=ΔL2. If the volume increment Δ3 is less than the volume increment Δ2, the ΔV3 is smaller than ΔV3. Therefore, compared with the fine parameter adjustment mode, when the touch displacement variations ΔL are the same, the volume variation of the precision parameter adjustment mode is smaller, thereby achieving a fine adjustment of the volume.

In detail, the block 109 further includes the following steps.

An adjusting command is sent in response to the third initiating command.

The second increment is decreased in response to the adjusting command until the parameter increment corresponding to a unit sliding distance is equal to the third increment, which is in the precision parameter adjustment mode.

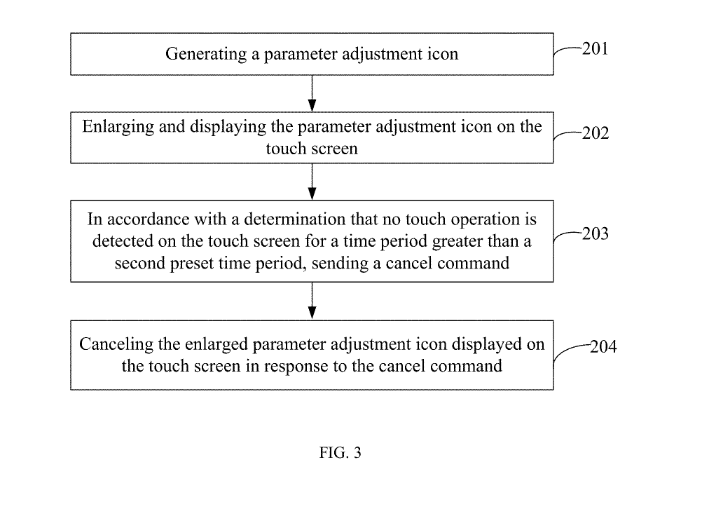

As illustrate in FIG. 3, furthermore, after initiating the fine parameter adjustment mode, the method further includes the following steps.

At block 201, a parameter adjustment icon is generated.

It is noted that, the parameter adjustment icon is a volume slider.

At block 202, the parameter adjustment icon is enlarged and displayed on the touch screen.

After enlarging the parameter adjustment icon, it is convenient to fine adjust the volume.

At block 203, in accordance with a determination that no touch operation is detected on the touch screen for a time period greater than a second preset time period, a cancel command is sent.

In accordance with a determination that no touch operation is detected on the touch screen for a time period greater than the second preset time period, it indicates that the volume has been completed adjustment, or the volume needs not fine adjust.

At block 204, the enlarged parameter adjustment icon displayed on the touch screen is canceled in response to the cancel command.

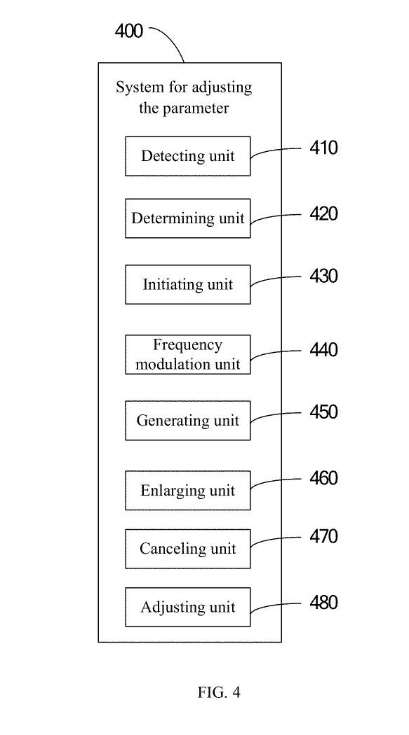

As illustrated in FIG. 4, a system 400 for adjusting the parameter of the mobile terminal device is provided by an exemplary embodiment of a second implementation of the present disclosure. The system 400 for adjusting the parameter of the parameter includes a detecting unit 410, a determining unit 420, and an initiating unit 430.

The detecting unit 410 is configured to detect a touch pressure on a touch screen of the mobile terminal device.

The mobile terminal device may be a headset, such as a head mount display. When a user needs to adjust some adjustable parameters of the mobile terminal device, the user may touch the touch screen firstly, and then slide on the touch screen to complete the adjustment of the corresponding parameter.

The determining unit 420 is configured to detect whether the touch pressure is greater than a preset pressure; send a first initiating command when the touch pressure is less than the preset pressure, and send a second initiating command when the touch pressure is greater than or equal to the preset pressure.

It is noted that, the preset pressure is configured to determine whether the user needs to select the coarse parameter adjustment mode or the fine parameter adjustment mode. Thus, the preset pressure may be adjusted according to an actual need. When the determining unit 420 determines that the touch pressure is less than the preset pressure, it indicates that the user needs coarse adjust the parameter. When the determining unit 420 determines that the touch pressure is greater than or equal to the preset pressure, it indicates that the user needs to fine adjust the parameter.

The initiating unit 430 is configured to initiate a coarse parameter adjustment mode in response to the first initiating command and to initiate a fine parameter adjustment mode in response to the second initiating command. In the coarse parameter adjustment mode, a parameter increment corresponding to the unit sliding distance is equal to a first increment. In the fine parameter adjustment mode, a parameter increment corresponding to the unit sliding distance is equal to a second increment. The second increment is smaller than the first increment.

The coarse parameter adjustment mode is initiated by the initiating unit 430 in response to the first initiating command, which means the mobile terminal device is in the coarse parameter adjustment mode. The initiating unit 430 initiates the fine parameter adjustment mode in response to the second initiating command, that is, the mobile terminal device is in the fine parameter adjustment mode. The parameter may be any attribute adjusted by the mobile terminal device, such as volume, brightness, or progress. In the exemplary embodiment, the parameter is volume. In other embodiments, the parameter may be brightness or progress.

It is noted that, the second increment may also be generated by directly reducing the first increment until the parameter increment corresponding to a unit sliding distance is equal to the second increment, which is in the fine parameter adjustment mode.

It is noted that, in the exemplary embodiment, the parameter increment corresponding to the unit sliding distance is the volume increment corresponding to the unit sliding distance, that is Δ=V/L, where, L represents the volume sliding distance; and V represents the total volume. That is, ΔV=Δ*ΔL, where, ΔV represents the variation of the volume when the touch displacement variation is ΔL.

In the coarse parameter adjustment mode, the parameter increment corresponding to the unit sliding distance is Δ=V/L, then ΔV1=Δ1*ΔL1. The parameter increment corresponding to the unit sliding distance in the fine parameter adjustment mode is Δ2=V/L, then ΔV2=Δ2*ΔL2. When a touch displacement variation of the fine parameter adjustment mode is the same as the touch displacement variation of the coarse parameter adjustment mode, that is, ΔL1=ΔL2. If the volume increment Δ2 is less than the volume increment Δ1, the ΔV2 is smaller than ΔV1. Therefore, compared with the coarse parameter adjustment mode, when the touch displacement variations ΔL are the same, the volume variation of the fine parameter adjustment mode is smaller, thereby achieving fine adjustment of the volume.

Therefore, in the exemplary embodiment, the system 400 for adjusting the parameter includes the detecting unit 410, the determining unit 420, and the initiating unit 430. The detecting unit 410 is configured to detect a touch pressure on a touch screen of the mobile terminal device. The determining unit 420 is configured to determine whether the touch pressure is greater than a preset pressure; send a first initiating command when the touch pressure is less than the preset pressure, and send a second initiating command when the touch pressure is greater than or equal to the preset pressure. The initiating unit 430 is configured to initiate a coarse parameter adjustment mode in response to the first initiating command and a fine parameter adjustment mode in response to the second initiating command. In the coarse parameter adjustment mode, a parameter increment corresponding to a unit sliding distance is equal to a first increment. In the fine parameter adjustment mode, a parameter increment corresponding to a unit sliding distance is equal to a second increment. The second increment is smaller than the first increment. Thus, the coarse parameter adjustment mode or fine parameter adjustment mode is alternatively initiated by the system 400 for adjusting the parameter to adjust the parameter in response to the touch pressure, that is, the parameter of the mobile terminal device is accurately adjusted according to an actual need to meet the user's application requirements.

Furthermore, the detecting unit 40 is further configured to detect a dwell time period of a touch object on the touch screen.

When the dwell time period is greater than or equal to a first preset time period, the determining unit 420 is further configured to send a third initiating command.

It is noted that, when the determining unit 420 determines that the dwell time period of the touch object on the touch screen is greater than the first preset time period, it indicates that the user wants fine adjust the volume.

The initiating unit 430 is configured to initiate a precision parameter adjustment mode. In the precision parameter adjustment mode, a parameter increment corresponding to the unit sliding distance is equal to a third increment; and the third increment is smaller than the second increment.

It is noted that, in the precision parameter adjustment mode, the parameter increment corresponding to a unit sliding distance is Δ3=V/L, then ΔV3=Δ3*ΔL3. When a touch displacement variation of the precision parameter adjustment mode is the same as the touch displacement variation of the fine parameter adjustment mode, that is, ΔL3=ΔL2. If the volume increment Δ3 is less than the volume increment Δ2, the ΔV3 is smaller than ΔV3. Therefore, compared with the fine parameter adjustment mode, when the touch displacement variations ΔL are the same, the volume variation of the precision parameter adjustment mode is smaller, thereby achieving a fine adjustment of the volume.

Specifically, the system 400 for adjusting the parameter further includes an adjusting unit 480.

The initiating unit 430 is further configured to send an adjusting command in response to the third initiating command.

The adjusting unit 480 is configured to decrease second increment in response to the adjusting command until the parameter increment corresponding to the unit sliding distance is equal to the third increment, which is in the precision parameter adjustment mode.

Furthermore, the system 400 for adjusting the parameter further includes a generating unit 450, an enlarging unit 460, and a canceling unit 470.

The generating unit 450 is configured to generate a parameter adjustment icon.

It is noted that, the parameter adjustment icon is a volume slider.

The enlarging unit 460 is configured to enlarge and display the parameter adjustment icon on the touch screen.

After enlarging the icon for adjusting the parameter, it is convenient for the users to adjust fine adjust the volume.

, the determining unit 420 is configured to send a cancel command in accordance with a determination that no touch operation is detected on the touch screen for a time period greater than a second preset time period.

In accordance with a determination that no touch operation is detected on the touch screen for a time period greater than a second preset time period, it indicates that the volume has been completed adjustment, or the volume needs not fine adjust.

The canceling unit 470 is configured to cancel the enlarged parameter adjustment icon displayed on the touch screen in response to the cancel command.

A mobile terminal device is provided by an exemplary embodiment of a third implementation of the present disclosure. The mobile terminal device includes the above system 400 for adjusting the parameter. The system 400 for adjusting the parameter has been described in detail in the foregoing second implementation, which will not be described in further details.

Therefore, in the exemplary embodiment, the mobile terminal device includes the system 400 for adjusting the parameter. The system 400 for adjusting the parameter includes the detecting unit 410, the determining unit 420, and the initiating unit 430. The detecting unit 410 is configured to detect a touch pressure on a touch screen of the mobile terminal device. The determining unit 420 is configured to determine whether the touch pressure is greater than a preset pressure; send a first initiating command when the touch pressure is less than the preset pressure, and send a second initiating command when the touch pressure is greater than or equal to the preset pressure. The initiating unit 430 is configured to initiate a coarse parameter adjustment mode in response to the first initiating command and a fine parameter adjustment mode in response to the second initiating command. In the coarse parameter adjustment mode, a parameter increment corresponding to a unit sliding distance is equal to a first increment. In the fine parameter adjustment mode, a parameter increment corresponding to the unit sliding distance is equal to a second increment. The second increment is smaller than the first increment. Thus, the coarse parameter adjustment mode or the fine parameter adjustment mode is alternatively initiated by the system 400 for adjusting the parameter to adjust the parameter in response to the touch pressure, that is, the parameter of the mobile terminal device is accurately adjusted according to an actual need, to meet the user's application requirements.

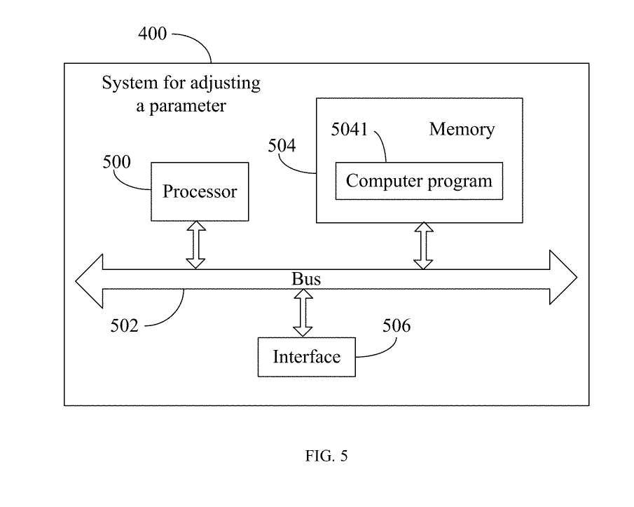

As illustrated in FIG. 5, these components illustrated in FIG. 4 can be integrated into a processor 500 for example. The processor 500 may be coupled to a memory 504 and at least one interface 506 by a bus 502. The memory 504 is configured to store at least one computer program which, when executed by the processor 500, becomes operable with the processor 500 to carry out the methods of the embodiments of the present disclosure. In addition, coupling or communication connection between each illustrated or discussed component may be direct coupling or communication connection, or may be indirect coupling or communication among devices or units by the at least one interface 506, and may be electrical connection, mechanical connection, or other forms of connection.

Embodiments of the present disclosure also provide a computer readable storage medium. The computer readable storage medium stores at least one computer program for electronic data interchange which, when executed, are operable with a computer to execute all or part of the operations of any of the method for adjusting a parameter of a mobile terminal device described in the above-described method embodiment.

In addition, the functional units in various embodiments of the present disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions for causing a computer device (which may be a personal computer, a server, or a network device and so on) to perform all or part of the steps described in the various embodiments of the present disclosure. The memory includes various medium capable of storing program codes, such as a USB (universal serial bus) flash disk, a read-only memory (ROM), a random-access memory (RAM), a removable hard disk, Disk, compact disc (CD), or the like.

It will be understood by those of ordinary skill in the art that all or a part of the various methods of the embodiments described above may be accomplished by means of a program to instruct associated hardware, the program may be stored in a computer-readable memory, which may include a flash memory, a read-only memory (ROM), a random-access memory (RAM), Disk or compact disc (CD), and so on.

The above disclosure is only the preferred embodiment of the present disclosure. It should be noted that those skilled in the art can also make several improvements and polish without departing from the principles of the present disclosure. These improvements and polish are also considered as the scope of the disclosure.

What is claimed is:

1. A method for adjusting a parameter of a mobile terminal device, comprising:
detecting a touch pressure on a touch screen of the mobile terminal device;
determining whether the touch pressure is greater than a preset pressure;
sending a first initiating command when the touch pressure is less than the preset pressure;
initiating a coarse parameter adjustment mode in response to the first initiating command, wherein in the coarse parameter adjustment mode, a parameter increment corresponding to a unit sliding distance is equal to a first increment;
sending a second initiating command when the touch pressure is greater than or equal to the preset pressure; and
initiating a fine parameter adjustment mode in response to the second initiating command; wherein in the fine parameter adjustment mode, a parameter increment corresponding to the unit sliding distance is equal to a second increment; and wherein the second increment is smaller than the first increment.

2. The method of claim 1, further comprising:
after initiating the fine parameter adjustment mode:
detecting a dwell time period of a touch object on the touch screen;
sending a third initiating command when the dwell time period is greater than or equal to a first preset time period; and
initiating a precision parameter adjustment mode in response to the third initiating command; wherein in the precision parameter adjustment mode, a parameter increment corresponding to the unit sliding distance is equal to a third increment; and
wherein the third increment is smaller than the second increment.

3. The method of claim 2, wherein initiating the precision parameter adjustment mode in response to the third initiating command comprises:
sending an adjusting command in response to the third initiating command; and
decreasing the second increment in response to the adjusting command until the parameter increment corresponding to the unit sliding distance is equal to the third increment, which is in the precision parameter adjustment mode.

4. The method of claim 1, further comprising:
after initiating the precision parameter adjustment mode:
generating a parameter adjustment icon;
enlarging and displaying the parameter adjustment icon on the touch screen;
in accordance with a determination that no touch operation is detected on the touch screen for a time period greater than a second preset time period, sending a cancel command; and
canceling the enlarged parameter adjustment icon displayed on the touch screen in response to the cancel command.

5. The method of claim 4, wherein the parameter adjustment icon is a slider.

6. The method of claim 1, wherein the parameter is volume.

7. A system for adjusting a parameter, comprising:
a processor; and
a memory coupled to the processor and configured to store at least one computer program which, when executed by the processor, performs operations comprising:
detecting a touch pressure on a touch screen of the mobile terminal device;
determining whether the touch pressure is greater than a preset pressure;
sending a first initiating command when the touch pressure is less than the preset pressure;
initiating a coarse parameter adjustment mode in response to the first initiating command, wherein in the coarse parameter adjustment mode, a parameter increment corresponding to a unit sliding distance is equal to a first increment;
sending a second initiating command when the touch pressure is greater than or equal to the preset pressure; and
initiating a fine parameter adjustment mode in response to the second initiating command; wherein in the fine parameter adjustment mode, a parameter increment corresponding to the unit sliding distance is equal to a second increment; and wherein the second increment is smaller than the first increment.

8. The system of claim 7, wherein the at least one computer program which, when executed by the processor, performs operations such that detecting the touch pressure on a touch screen of the mobile terminal device comprises:
detecting a dwell time period of a touch object on the touch screen;
the at least one computer program which, when executed by the processor, performs operations such that determining whether the touch pressure is greater than a preset pressure comprises:
sending a third initiating command when the dwell time period is greater than or equal to a first preset time period; and
the at least one computer program which, when executed by the processor, performs operations such that initiating the coarse parameter adjustment mode in response to the first initiating command, and initiating the fine parameter adjustment mode in response to the second initiating command comprises:
initiating a precision parameter adjustment mode in response to the third initiating command; and wherein in the precision parameter adjustment mode, a parameter increment corresponding to the unit sliding distance is equal to a third increment; and wherein the third increment is smaller than the second increment.

9. The system of claim 8, wherein the at least one computer program which, when executed by the processor, performs operations such that initiating the coarse parameter adjustment mode in response to the first initiating command, and initiating the fine parameter adjustment mode in response to the second initiating command comprises:
sending an adjusting command to the processor in response to the third initiating command; and
the at least one computer program which, when executed by the processor, performs operations comprising :
decreasing the second increment in response to the adjusting command until the parameter increment corresponding to a unit sliding distance is equal to the third increment, which is in the precision parameter adjustment mode.

10. The system of claim 7, wherein the at least one computer program which, when executed by the processor, performs operations comprising:
generating parameter adjustment icon;
enlarging and displaying the parameter adjustment icon on the touch screen;
sending a cancel command in accordance with a determination that no touch operation is detected on the touch screen for a time period greater than a second preset time period; and
canceling the enlarged parameter adjustment icon displayed on the touch screen in response to the cancel command.

11. The system of claim 10, wherein the parameter adjustment icon is a slider.

12. The system of claim 7, wherein the parameter is volume.

13. A mobile terminal device, comprising a processor, a memory, an interface, and a bus, the processor is coupled to the memory and the interface by the bus;
the memory is configured to store at least one computer program which, when executed by the processor, performs operations comprising:
detecting a touch pressure on a touch screen of the mobile terminal device;
determining whether the touch pressure is greater than a preset pressure;
sending a first initiating command when the touch pressure is less than the preset pressure;
initiating a coarse parameter adjustment mode in response to the first initiating command, wherein in the coarse parameter adjustment mode, a parameter increment corresponding to a unit sliding distance is equal to a first increment;
sending a second initiating command when the touch pressure is greater than or equal to the preset pressure; and
initiating a fine parameter adjustment mode in response to the second initiating command; wherein in the fine parameter adjustment mode, a parameter increment corresponding to the unit sliding distance is equal to a second increment; and wherein the second increment is smaller than the first increment.

14. The mobile terminal device of claim 13, wherein the at least one computer program which, when executed by the processor, performs operations such that detecting the touch pressure on the touch screen of the mobile terminal device comprises:
detecting a dwell time period of a touch object on the touch screen;
the at least one computer program which, when executed by the processor, performs operations such that determining whether the touch pressure is greater than the preset pressure comprises:
sending a third initiating command when the dwell time period is greater than or equal to a first preset time period; and
the at least one computer program which, when executed by the processor, performs operations such that initiating the coarse parameter adjustment mode in response to the first initiating command, and initiating the fine parameter adjustment mode in response to the second initiating command comprises:
initiating a precision parameter adjustment mode in response to the third initiating command; and wherein in the precision parameter adjustment mode, a parameter increment corresponding to the unit sliding distance is equal to a third increment; and wherein the third increment is smaller than the second increment.

15. The mobile terminal device of claim 14, wherein the at least one computer program which, when executed by the processor, performs operations such that initiating the coarse parameter adjustment mode in response to the first initiating command, and initiating the fine parameter adjustment mode in response to the second initiating command comprises:
sending an adjusting command to the processor in response to the third initiating command; and
the at least one computer program which, when executed by the processor, performs operations comprising :
decreasing the second increment in response to the adjusting command until the parameter increment corresponding to a unit sliding distance is equal to the third increment, which is in the precision parameter adjustment mode.

16. The mobile terminal device of claim 13, wherein the at least one computer program which, when executed by the processor, performs operations comprising :
generating parameter adjustment icon;
enlarging and displaying the parameter adjustment icon on the touch screen;
sending a cancel command in accordance with a determination that no touch operation is detected on the touch screen for a time period greater than a second preset time period; and
canceling the enlarged parameter adjustment icon displayed on the touch screen in response to the cancel command.

17. The mobile terminal device of claim 16, wherein the parameter adjustment icon is a slider.

18. The mobile terminal device of claim 13, wherein the parameter is volume.
